(19) United States
(12) Patent Application Publication
(10) Pub. No.: US 2016/0241766 A1
(43) Pub. Date: Aug. 18, 2016

(54) METHOD OF DISABLING TRANSMISSION AND CAPTURE OF VISUAL CONTENT ON A DEVICE TO PROTECT FROM INAPPROPRIATE CONTENT

(71) Applicant: INTERNATIONAL BUSINESS MACHINES CORPORATION, Armonk, NY (US)

(72) Inventors: Michael BENDER, Rye Brook, NY (US); David E. NACHMAN, Morristown, NJ (US); Michael P. SHUTE, New Rochelle, NY (US)

(21) Appl. No.: 14/620,248

(22) Filed: Feb. 12, 2015

(51) Int. Cl. H04N 5/232

(52) U.S. Cl. CPC H04N 5/23203

(57) ABSTRACT

An approach includes prohibiting inappropriate content. The approach includes accessing a camera. The approach further includes capturing at least one image using the camera. The approach further includes determining whether the at least one captured image is compliant with the content rules. The approach further includes prohibiting durable persistence of the at least one captured image in the device in response to the determination that the at least one captured image is not compliant with the content rules. The approach further includes allowing the durable persistence of the at least one captured image in the device in response to the determination that the at least one captured image is compliant with the content rules.

### FIELD OF THE INVENTION

The present invention generally relates to disabling transmission and capture of visual content on a device, and more particularly, to a method and system for disabling transmission and capture of visual content on a device to protect from inappropriate content.

### BACKGROUND

With the explosion of mobile device technology, the capture of visual images and videos is now in the hands of more users than ever before. This content can be captured in nearly every situation imaginable and mobile ecosystems encourage the social sharing and publishing of this content. With this ability, there is considerable need for discretion so that potentially embarrassing, harmful, or incriminating artifacts are not shared by both minors and adults.

Parental controls are known to limit access to web properties that contain questionable material. Other solutions focus on validating content at the point of sharing. But none of these solutions prevent the content from leaving the origination point.

### SUMMARY

In a first aspect of the invention, a method is provided for that includes accessing a camera. The method further includes capturing at least one image using the camera. The method further includes determining whether the at least one captured image is compliant with content rules. The method further includes prohibiting durable persistence of the at least one captured image in the device in response to the determination that the at least one captured image is not compliant with the content rules. The method further includes allowing the durable persistence of the at least one captured image in the device in response to the determination that the at least one captured image is compliant with the content rules.

In another aspect of the invention, there is a computer program product for prohibiting inappropriate conduct. The computer program product includes a computer usable storage medium having program code embodied in the storage medium. The program code is not a transitory signal per se, and the program instructions are readable by a computing device to cause the computing device to perform a method that includes accessing a camera connected to the computing device through an operating system of the computing device. The method further includes capturing at least one image using the camera connected to the computing device. The method further includes loading content rules which are stored in the operating system of the computing device. The method further includes determining whether the at least one captured image is compliant with the loaded content rules. The method further includes prohibiting durable persistence of the at least one captured image in the computing device in response to the determination that the at least one captured image is not compliant with the loaded content rules to prevent sharing of the at least one captured image. The method further includes allowing the durable persistence of the at least one captured image in the computing device in response to the determination that the at least one captured image is compliant with the loaded content rules.

In a further aspect of the invention, a system is provided that includes a CPU, a computer readable memory and a computer readable storage medium. Additionally, the system includes one or more program instructions. The system includes program instructions to access a camera connected to a device through an application in an application programming interface of the device. The system further includes program instructions to capture at least one image using the camera connected to the device. The system further includes program instructions to load content rules which are stored in the application programming interface of the device. The system further includes program instructions to determine whether the at least one captured image is compliant with the loaded content rules. The system further includes program instructions to prohibit durable persistence of the at least one captured image in the device in response to the determination that the at least one captured image is not compliant with the loaded content rules to prevent sharing of the at least one captured image. The system further includes program instructions to allow the durable persistence of the at least one captured image in the device in response to the determination that the at least one captured image is compliant with the loaded content rules. The program instructions are stored on the computer readable storage medium for execution by the CPU via the computer readable memory.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with aspects of the invention.

FIG. 2 shows a high level architecture for implementing processes in accordance with aspects of the invention.

FIG. 3 shows a device architecture for implementing processes in accordance with aspects of the invention.

FIG. 4 shows an exemplary flow in accordance with aspects of the invention.

FIG. 5 shows an operating system (O/S) flow in accordance with aspects of the invention.

FIG. 6 shows an application programming interface (API) flow in accordance with aspects of the invention.

FIG. 7 shows an exemplary flow in accordance with aspects of the invention.

### DETAILED DESCRIPTION

The present invention generally relates to disabling transmission and capture of visual content on a device, and more particularly, to a method and system for disabling transmission and capture of visual content on a device to protect from inappropriate content. More specifically, the systems and methods described herein provides a computing device (e.g., a tablet, a smart phone, etc.) with an application that audits the image being captured by the camera. If the image is determined to contain content that is not appropriate, the device would not allow the image to be saved or for other applications to use the data or transmit the image (e.g., social media or communication applications) The content screening detects by way of example, nudity, but additional content rules could be used that would cover other inappropriate behavior or actions or objects, e.g., intoxicated individuals, drug paraphernalia, confidential information, or other inappropriate pictures. The content rules may be linked to a computing device that would be in control of the content rules, receive notification of attempts to get past the rules, and unlock the device for future uses.

In embodiments, the application would be loaded on a device before image capturing occurs. At the time of when an image is taken by the device, the image will be examined (through the content rules) before it is freed (i.e., allowed) to be saved or used by other applications. In embodiments, the image will be analyzed to see if it has any inappropriate content based on a controlled set of rules managed externally from the applications of the device. These results will make up a series of checks which will verify if the image contains an instance of something deemed inappropriate by an external party. Each check will be performed on the image and only when the image is deemed to have passed (i.e., not containing any inappropriate content), can the image be saved and used on the device.

Most modern devices (e.g., smart devices) provide one or more cameras for the capture of visual content. Within the framework and services that are provided to application developers, there is an application programming interface (API) to gain access to the camera, control the execution of the camera, and retrieve and store the resulting visual content. Additionally, a core operating system (OS) provides known systems to implement permissions and policies for what services can be used by applications.

Embodiments of the invention deal with analyzing the visual content being captured, and if it contains content that is inappropriate, preventing the transmission and durable persistence of that information. Embodiments can be implemented in different ways: as part of the core layer of the operating system and its hardware layer/libraries or as a layer within the application framework. As part of the core layer of the operating system, the implementation can be secure and safe. To implement, modifications would be made at the hardware abstraction layer and libraries. As a hardware camera is directed to capture content, the content would be passed through the content rules and their algorithms to check for compliance. If the content is non-compliant, the library would not allow the content to be passed back to the application framework or any application layer. In embodiments, this implementation could include a hard error or could pass blank content back to the application framework. The content rules applied would be based on a system security policy. In this implementation, any display of the content would be prevented, including image previews. Therefore, in this implementation, any circumvention attempts, such as taking a screenshot before the image is written to persistent storage, would be prohibited.

As part of the application framework, a similar scenario would occur. As the API is called to communicate with the camera, the content is passed to the application framework layer. In the application framework layer, the runtime applies the content rules and algorithms for compliance based on security settings. If the content is non-compliant, the framework would not allow the content to be consumed by the application, either by returning an error or passing blank content back to the API calls.

The content rules would be implemented using algorithms, as shown and described with respect to the flow diagrams, to detect specific objects or color/flesh tones. As the image (i.e., visual content) is captured, the algorithm for the content rules is applied to the content. The core OS or API then determines if the resulting output from the algorithm computations represents prohibited content. The determination is done by checking internal configuration settings on what content rules need to be applied and to what degree (e.g., amount of exposed skin). These internal configuration settings would be protected by the operating system and would only be changed by an authorized application. For example, the operating system would provide a mechanism to enable/disable the content rules that an original equipment manufacturer (OEM) could access. Additionally, the manufacturer may provide a user application to turn some of these settings on (analogous to parental controls). The control rules and their algorithms may be provided in the operating system stack, and the activation of the rules and the settings would be in the OEM implementation.

Although the present invention is described hereafter with regard to exemplary methods, and/or computer program products, it should be understood that other implementations are also contemplated by the present invention as described herein. For example, other devices, systems, appliances, and/or computer program products according to embodiments of the invention will be or become apparent to one of ordinary skill in the art upon review of the following drawings and detailed description. It is intended that all such additional other devices, systems, appliances, processes, and/or computer program products be included within this description and within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

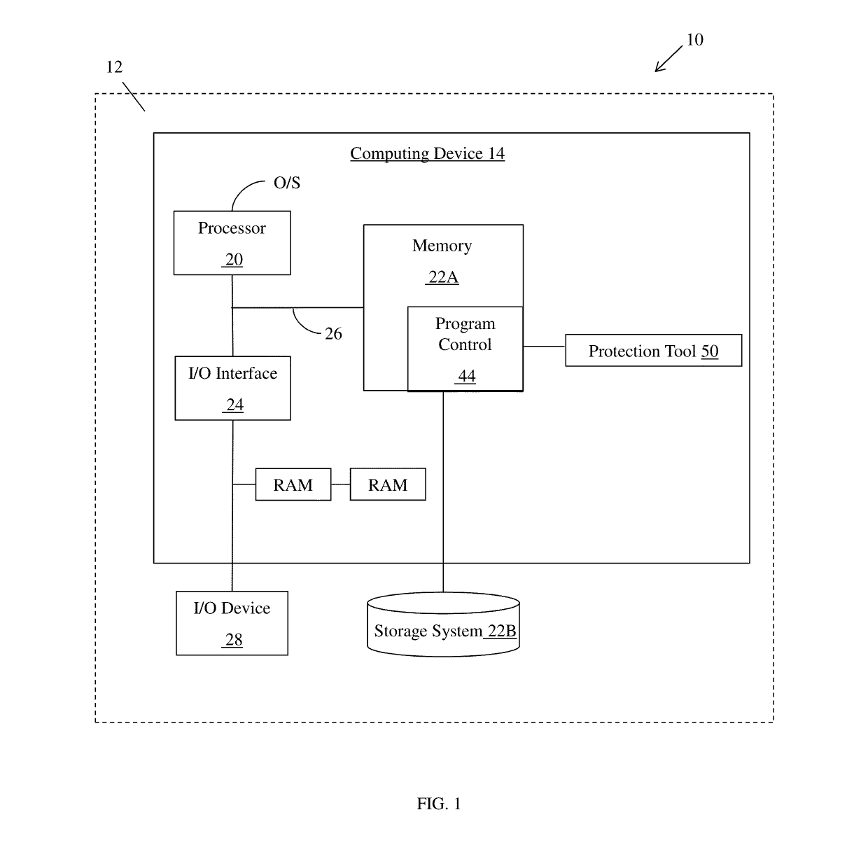

FIG. 1 shows an illustrative environment 10 for managing the processes in accordance with the invention. To this extent, environment 10 includes a server 12 or other computing system that can perform the processes described herein. In particular, server 12 includes a computing device 14. The computing device 14 can be resident on a network infrastructure or computing device of a third party service provider (any of which is generally represented in FIG. 1).

The computing device 14 also includes a processor 20 (e.g., CPU), memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with external I/O device/resource 28 and storage system 22B. For example, I/O device 28 can comprise any device that enables an individual to interact with computing device 14 (e.g., user interface) or any device that enables computing device 14 to communicate with one or more other computing devices using any type of communications link. The external I/O device/resource 28 may be for example, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a protection tool 50, which performs the processes described herein. The protection tool 50 can be implemented as one or more program code in program control 44 stored in memory 22A as separate or combined modules. Additionally, the protection tool 50 may be implemented as separate dedicated processors or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in computing device 14.

By way of example, the protection tool 50 may be configured to prevent transmission and capture of visual content on a device to protect from saving and sending inappropriate content over a communication protocol, e.g., social networks, texting, email, etc. The protection tool 50 may be configured to be loaded on a device before image capturing occurs. When an image is taken by the device, the image will be examined by the protection tool 50 using various content rules. The content rules verify if the image contains inappropriate content (e.g., drug paraphernalia, inappropriate images, confidential information, etc.) If the content rules verify that the image is appropriate, the protection tool 50 allows the durable persistence of image on the device (i.e., saving the image on the device). However, if the content rules determine that the image is inappropriate, the protection tool 50 prevents the image from having durable persistence on the device. In this latter case, it would then not be possible to send or post such image for others viewing.

The computing device 14 can comprise any general purpose computing article of manufacture capable of executing computer program code installed thereon (e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, server 12 is only illustrative of various types of computer infrastructures for implementing the invention. For example, in embodiments, server 12 comprises two or more computing devices (e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

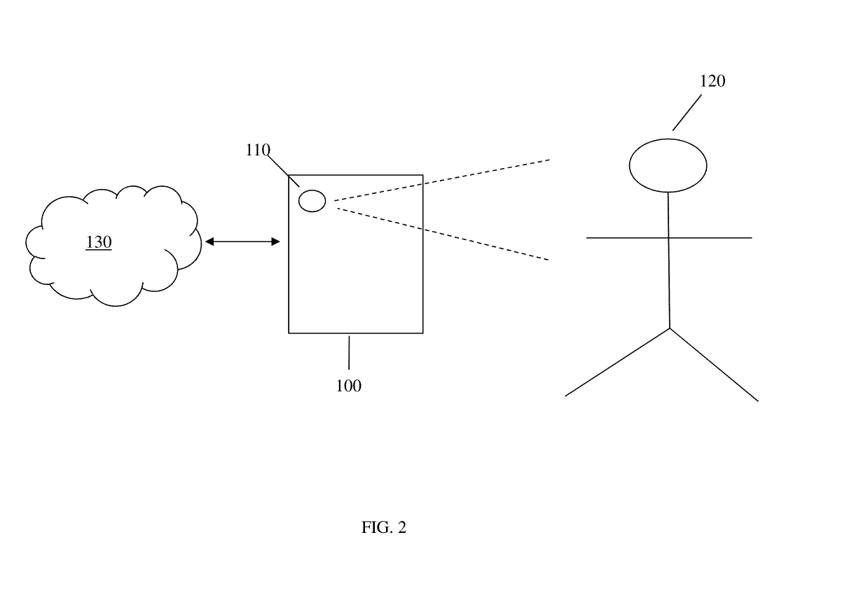

FIG. 2 is a high level architecture for implementing processes in accordance with aspects of the present invention. More specifically, FIG. 2 depicts a device 100 including a camera 110, a user 120, and a network 130. In embodiments, device 100 may be any computing device, including a smart phone, a tablet, a laptop, a desktop computer, or any other device which is connected to or contains a camera 110 (e.g., digital camera). Further, network 130 may be the Internet, a local area network, a wide area network, and/or a wireless network. In embodiments, device 100 may be configured to communicate with the network 130 in order to send images, documents, videos, and/or other data. Although example embodiments may describe capturing images using camera 110, video, documents, and/or other data may be captured using camera 110 and are within the scope of the embodiments.

In FIG. 2, user 120 may position device 100 in order to take a picture of himself/herself (e.g., “a selfie”) using camera 110 of device 100. In further embodiments, another user may take a picture of user 120 using camera 110 of device 100, or user 120 may take a picture of another object or person using camera 110 of device 100. However, embodiments are not limited to the above, and may include any picture taken using camera 110 of device 100.

Referring still to FIG. 2, in use, user 120 takes a picture of himself/herself (e.g., “a selfie”) using camera 110 of device 100. In known systems, the image is automatically saved in device 100 after it is captured. In other words, the image has a durable persistence by residing in device 100 after an image capture by camera 110 of device 100. In contrast, in embodiments, the captured image is examined against various content rules before there is any durable persistence in device 100. In other words, after camera 110 of device 100 captures an image but before there is any durable persistence in device 100, the captured image is analyzed against various content rules to ensure that the image does not contain any inappropriate content. If the analysis of the captured image determines that the captured image contains inappropriate content, the captured image is prevented from having any durable persistence (i.e., being saved) in device 100. Therefore, device 100 would not save any captured image that fails any of the various content rules. This prevents the captured image from being shared on network 130 by user 120 or being retrieved by another person using the device 100.

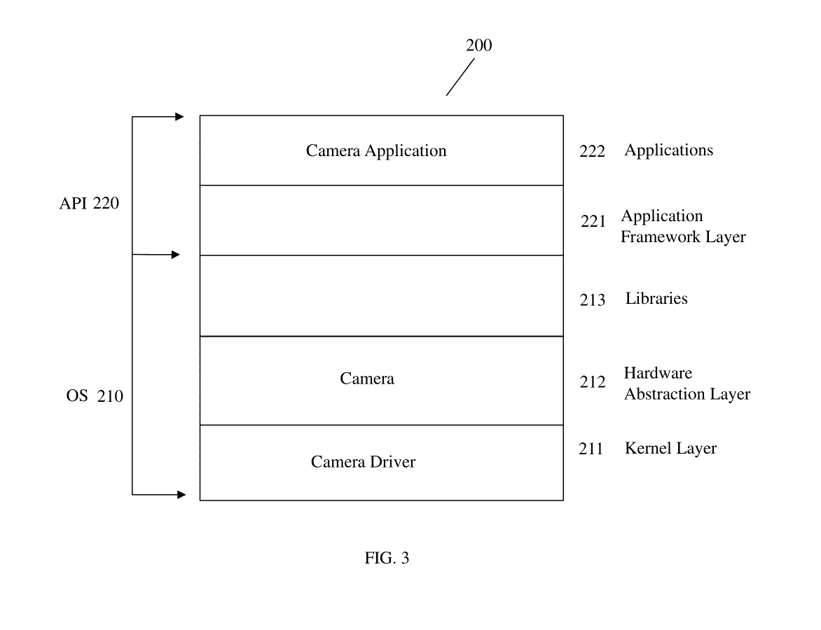

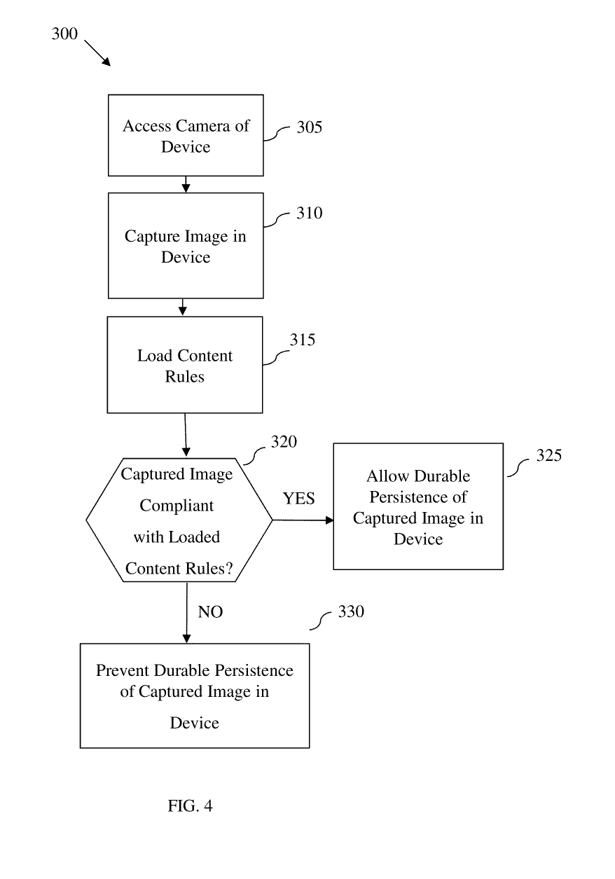

FIG. 3 is a device architecture for implementing processes in accordance with aspects of the invention. Although FIG. 3 shows one example of device architecture 200 for device 100, one of ordinary skill in the art would understand that various hardware abstraction layers may be used for device 100. In other words, various hardware abstraction layers for device 100 are within the scope of the invention. In FIG. 3, device architecture 200 may include an application programming interface (API) 220 and a core operating system (OS) 210. The API 220 may further include an application framework layer 221 and applications 222. The OS 210 may further include a kernel layer 211, a hardware abstraction layer 212, and libraries 213. In embodiments, the hardware abstraction layer 212 may contain camera 110 and the kernel layer 211 may contain a camera driver for controlling camera 110 in the hardware abstraction layer 212. Further, one of the applications 222 in the API 220 may be a camera application. The camera application may be used with the camera driver in the kernel layer 211 for controlling camera 110 in the hardware abstraction layer 212. Alternatively, camera 110 in the hardware abstraction layer 212 may be directly controlled in the OS 210 without using any of the applications 222 in the API 220. The processes for controlling camera 110 will be described in FIGS. 4-7.

### Flow Diagram

FIGS. 4-7 show exemplary flows for performing aspects of the present invention. The steps of FIGS. 4-7 may be implemented in the environment of FIG. 1, for example. As noted above, the flowcharts of FIGS. 4-7 illustrate the architecture, functionality, and operation of possible implementations of systems, methods, and computer program products according to various embodiments of the present invention. The flowchart and block diagrams in the Figures illustrate the architecture, functionality, and operations of possible implementations of systems, methods, and computer program products according to various embodiments of the present invention. In this regard, each block in the flowchart or block diagrams may represent a module, segment, or portion of code, which comprises one or more executable instructions for implementing the specified logical functions. It should also be noted that, in some alternative implementations, the functions noted in the block may occur out of the order noted in the figures. For example, two blocks show in succession may, in fact, be executed substantially concurrently, or the blocks may sometimes be executed in the reverse order, depending upon the functionality involved. It will also be noted that each block of the block diagrams and/or flowchart illustration, and combination of blocks in the block diagrams and/or flowchart illustration, can be implemented by special purpose hardware-based systems that perform the specified functions or acts, or combinations of special purpose hardware and computer instructions.

FIG. 4 depicts an exemplary flow for a process in accordance with aspects of the present invention. In FIG. 4, at step 305, user 120 may access camera 110 of device 100. In embodiments of FIG. 4, accessing of camera 110 of device 100 may occur at the API 220 or the OS 210 level. If the user 120 accesses camera 110 at the API 220 level, camera 110 can be accessed through a camera application or any other application with image capturing functionality. At step 310, user 120 may capture an image in device 100. In embodiments, user 120 may tap or click on a predefined area of the screen or depress a button on a side of device 100. However, other embodiments for performing image capture in device 100 may also be used as is well known to those of ordinary skill in the art. At step 315, content rules may be stored and loaded from the O/S 210 level. Alternatively, the content rules may be stored and loaded from the API 220 level. However, embodiments are not limited to the above and, as such, the content rules may be stored on network 130 or a secondary device and transmitted to device 100 through a wired and/or wireless network. At step 320, a determination is made whether the captured image in device 100 is compliant with the content rules. If the captured image in device 100 is compliant with loaded content rules (i.e., YES), at step 325, the captured image is allowed to be durably persistent (i.e., saved) in device 100. Once the content is saved, it can be sent via the network or posted on a social site, as should be understood by those of ordinary skill in the art. Alternatively, at step 330, if the captured image in device 100 is not compliant with loaded content rules, then the captured image is prevented from being durably persistent in device 100. As the content is not saved, it cannot be sent via the network or posted on a social site, as should be understood by those of skill in the art.

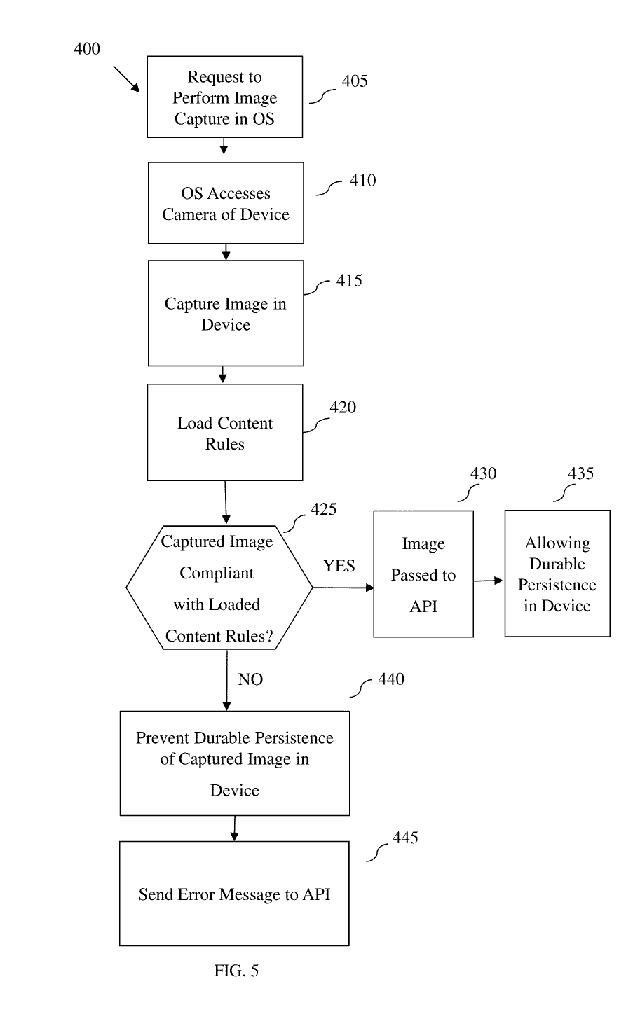

FIG. 5 is an operating system (O/S) flow in accordance with aspects of the invention. In other words, FIG. 5 is a situation where the camera 110 is in the hardware abstraction layer 212 and may be directly controlled by the OS 210 level without using any of the applications 222 in the API 220 level. At step 405, a request to perform image capture is received in the OS 210 level. The request may come from an administrative user, a developer, or any other person who has direct access to the functions in the OS 210. At step 410, after the OS 210 receives the request, the OS 210 accesses camera 110 directly or through the API 220.

At step 415, the image may be captured after the OS 210 accesses camera 110. At step 420, the content rules may be stored and loaded from the OS 210 level. Alternatively, the content rules may be stored and loaded from the API 220 level. However, embodiments are not limited to the above implementations, and the content rules may be stored on network 130 or a secondary device and transmitted to device 100 through a wired and/or wireless network. At step 425, a determination is made whether the captured image in device 100 is compliant with loaded content rules. If the captured image in device 100 is compliant with loaded content rules (i.e., YES), at steps 430 and 435, the image may be passed to the API 220 level and/or the OS 210 level for durable persistence (i.e., being saved) in device 100. Alternatively, if the captured image in device 100 is not compliant with loaded content rules (i.e., NO), then at steps 440 and 445, the captured image is prevented from being durably persistent in device 100 and an error message is sent to the API 220 level and passed to user 120 directly or through one of the applications 222. However, the error message may be any message that informs the user that the captured image is not capable of being durably persistent in device. Similar to the embodiment described in FIG. 4, if the content is saved, it can be sent via the network or posted on a social site, as should be understood by those of ordinary skill in the art. Alternatively, if the content is not saved, it cannot be sent via the network or posted on a social site, as should be understood by those of skill in the art.

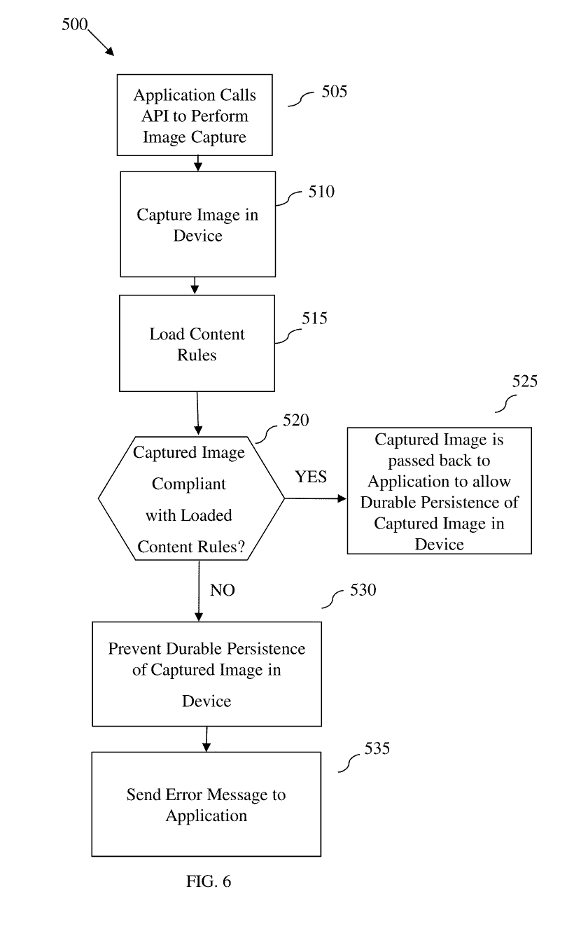

FIG. 6 is an application programming interface (API) flow in accordance with aspects of the invention. In other words, FIG. 6 is a situation where the applications 222 in the API 220 level control camera 110. At step 505, one of the applications 222 accesses camera 110 through the API 220. At step 510, the image may be captured after one of the applications 222 accesses camera 110. At step 515, the content rules may be stored and loaded from the API 220 level. Alternatively, the content rules may be stored and loaded from the OS 210 level. However, embodiments are not limited, and the content rules may be stored on network 130 or a secondary device and transmitted to device 100 through a wired and/or wireless network. At step 520, a determination is made whether the captured image in device 100 is compliant with loaded content rules. If the captured image in device 100 is compliant with loaded content rules (i.e., YES), at step 525, then the captured image may be passed to the API 220 level for durable persistence (e.g., being saved) in device 100. Alternatively, if the captured image in device 100 is not compliant with loaded content rules (i.e., NO), then at steps 530 and 535, the captured image is prevented from being durably persistent in device 100 and an error message is sent to the API 220 level and is then passed to user 120 directly or through one of the applications 222. The error message may state that the captured image is deemed to be inappropriate content. However, the error message may be any message that informs the user that the captured image is not capable of being durable persistent in device.

Similar to the embodiments described in FIGS. 4 and 5, if the content is saved, it can be sent via the network or posted on a social site, as should be understood by those of skill in the art. Alternatively, if the content is not saved, it cannot be sent via the network or posted on a social site, as should be understood by those of skill in the art.

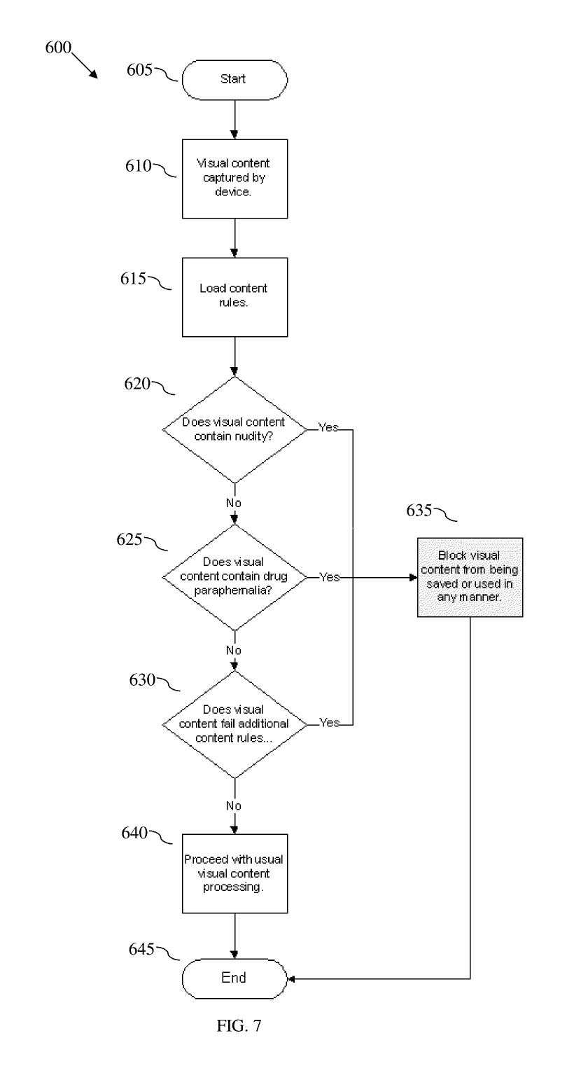

FIG. 7 is an exemplary flow in accordance with aspects of the invention. In FIG. 7, at step 605, the exemplary flow starts. At step 610, visual content is captured by device 100. At step 615, content rules are loaded. The content rules may be stored and loaded from the OS 210 level. Alternatively, the content rules may be stored and loaded from the API 220 level. However, embodiments are not limited, and the content rules may be stored on network 130 or a secondary device and transmitted to device 100 through a wired and/or wireless network. At steps 620, 625, and 630, a determination is made whether the visual content in device 100 is compliant with each of the content rules. In particular, at step 620, the visual content in device 100 is examined to determine whether the visual content contains nudity. At step 625, the visual content in device 100 is examined to determine whether the visual content contains drug paraphernalia. At step 630, the visual content in device 100 is examined to determine whether the visual content fails additional content rules (e.g., confidential information, other questionable conduct, etc.) If the visual content in device 100 contains nudity, drug paraphernalia, or fails additional content rules (i.e., YES), at step 635, the visual content is blocked from being saved or used in any manner by device 100. In contrast, if the visual content in device 100 does not contain nudity or drug paraphernalia and does not fail additional content rules (i.e., NO), at step 640, device 100 proceeds with usual visual content processing. At step 645, the exemplary flow ends.

In embodiments, the integration of an application with content rules in a computing device would prohibit the sharing or saving of captured visual content when there has been a determination that the visual content includes inappropriate content by the content rules. In embodiments, a method would allow activation of content rules to an electronic device with integrated capture capabilities from a trusted source. Further, the selection of content rules would be customizable to meet the needs and norms of different communities. For example, the content rules may be customized based on societal norms of a community using the device. In embodiments, data content from the camera would not be saved or made available to applications if it is determined that the data content does not meet the content rules.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented in a computer infrastructure having computer executable code tangibly embodied on a computer readable storage medium having programming instructions configured to:
access a camera;
capture at least one image using the camera;
determine whether the at least one captured image is compliant with content rules;
prohibit durable persistence of the at least one captured image in the device in response to the determination that the at least one captured image is not compliant with the content rules; and
allow the durable persistence of the at least one captured image in the device in response to the determination that the at least one captured image is compliant with the content rules.

2. The method of claim 1, wherein the durable persistence of the at least one captured image comprises at least one of saving the at least one captured image in the device and allowing the at least one captured image to be used by applications in the device.

3. The method of claim 1, wherein the content rules are customized.

4. The method of claim 1, wherein the content rules include at least one rule which prohibits one of a predetermined content type and confidential information in the at least one captured image.

5. The method of claim 1, wherein the camera is directly accessed by an operating system of the device.

6. The method of claim 5, wherein the content rules are stored in the operating system of the device.

7. The method of claim 1, wherein the camera is accessed by at least one application in an application programming interface of the device.

8. The method of claim 7, wherein the content rules are stored in the application programming interface of the device.

9. The method of claim 1, further comprising sending an error message which states that the at least one captured image is not capable of durable persistence in the device because the at least one captured image is inappropriate content.

10. The method of claim 1, wherein the programming instructions are further configured to load the content rules from a storage device.

11. The method of claim 1, wherein the capturing the at least one image using the camera connected to the device does not allow for the durable persistence of the at least one captured image in the device before the content rules are loaded.

12. The method of claim 1, wherein the device is a mobile device.

13. The method of claim 1, wherein an operating system of the device allows the content rules to be disabled.

14. The method of claim 1, wherein a service provider at least one of creates, maintains, deploys and supports the computer infrastructure.

15. The method of claim 1, wherein steps of claim 1 are provided by a service provider on a subscription, advertising, and/or fee basis.

16. A computer program product for prohibiting inappropriate content, the computer program product comprising a computer readable storage medium having program instructions embodied therewith, wherein the computer readable storage medium is not a transitory signal per se, and the program instructions are readable by a computing device to cause the computing device to perform a method comprising:
accessing a camera connected to the computing device through an operating system of the computing device;
capturing at least one image using the camera connected to the computing device;
loading content rules which are stored in the operating system of the computing device;
determining whether the at least one captured image is compliant with the loaded content rules;
prohibiting durable persistence of the at least one captured image in the computing device in response to the determination that the at least one captured image is not compliant with the loaded content rules to prevent sharing of the at least one captured image; and
allowing the durable persistence of the at least one captured image in the computing device in response to the determination that the at least one captured image is compliant with the loaded content rules.

17. The computer program product of claim 16, wherein the durable persistence of the at least one captured image in the computing device comprises at least one of saving the at least one captured image in the computing device and allowing the at least one captured image to be used by applications in the computing device.

18. The computer program product of claim 16, wherein the content rules are customized.

19. The computer program product of claim 16, further comprising sending an error message which states that the at least one captured image is not capable of durable persistence in the computing device because the at least one captured image is inappropriate content.

20. A system comprising:
a CPU, a computer readable memory and a computer readable storage medium;
program instructions to access a camera connected to a device through an application in an application programming interface of the device;
program instructions to capture at least one image using the camera connected to the device;
program instructions to load content rules which are stored in the application programming interface of the device;
program instructions to determine whether the at least one captured image is compliant with the loaded content rules;
program instructions to prohibit durable persistence of the at least one captured image in the device in response to the determination that the at least one captured image is not compliant with the loaded content rules to prevent sharing of the at least one captured image; and
program instructions to allow the durable persistence of the at least one captured image in the device in response to the determination that the at least one captured image is compliant with the loaded content rules,
wherein the program instructions are stored on the computer readable storage medium for execution by the CPU via the computer readable memory.
